(19) United States
(12) Patent Application Publication
(10) Pub. No.: US 2026/0225230 A1
(43) Pub. Date: Aug. 6, 2026

(54) ROBOT CONTROL APPARATUS AND ROBOT SYSTEM

(71) Applicant: FANUC CORPORATION, Yamanashi (JP)

(72) Inventor: Rintaro NAKANO, Yamanashi (JP)

(73) Assignee: FANUC CORPORATION, Yamanashi (JP)

(21) Appl. No.: 19/150,171

(22) PCT Filed: Feb. 24, 2023
(86) PCT No.: PCT/JP2023/006767

§ 371 Date: Jul. 22, 2025

(51) Int. Cl. B25J 9/16; B25J 13/08; B25J 15/06; G01L 21/00

(52) U.S. Cl. CPC B25J 9/1612; B25J 13/085; B25J 15/0616; G01L 21/00

(57) ABSTRACT

Provided is a robot control apparatus capable of ascertaining at least one of the width, depth, or height of an object to be conveyed, by using at least two holding force values. The robot control apparatus controls an operation of a robot that has a robot hand provided with at least two sensors, each measuring a holding force, and that uses the robot hand to hold an object placed at a first location and place the object at a second location. The robot control apparatus is provided with at least one processor and at least one storage device capable of storing a program to be executed. The at least one processor determines at least one of the width, depth, or height of the object by using at least two holding force values measured by the at least two sensors, on the basis of the program.

### TECHNICAL FIELD

The present disclosure pertains to a robot control apparatus and a robot system, and particularly pertains to a robot control apparatus that controls operation of a robot, which holds and conveys an object, as well as a robot system that includes the robot control apparatus and the robot.

### BACKGROUND ART

Patent Documents 1 and 2 describe techniques for a robot to stably hold and convey an object.

Patent Document 1 describes a conveyance apparatus that can convey a package in a state where the package is stably held, and a conveyance program. Specifically, the conveyance apparatus described in Patent Document 1 has a holding unit, a driving unit, a force sensor, a first obtainment unit, a determination unit, and a control unit. The holding unit holds the package, the driving unit causes the holding unit to move, and the force sensor detects a force applied between the holding unit and the driving unit. The first obtainment unit obtains holding information that indicates a hold state in which the holding unit holds the package. The determination unit determines whether to cause the package to be conveyed, based on the holding information indicating the hold state of the holding unit that was obtained by the first obtainment unit, and a result of detection by the force sensor. The control unit causes the driving unit to convey the package in a case where the determination unit has determined to cause conveyance of the package.

Patent Document 2 describes a food product holding apparatus that can reliably hold a food product in a limited workspace, and addresses streamlining work for packing the food product. Specifically, Patent Document 2 describes a holding apparatus for a food product in which a food product body has been accommodated in a bag body. This holding apparatus is provided with a plurality of pairs of holding member that are configured to pinch along a prescribed direction and thereby hold each apex section of a plurality of food product bag bodies that are overlapped at prescribed positions in the prescribed direction. Two pairs of the holding members that are adjacent to one another in the prescribed direction are at different positions in a direction orthogonal to the prescribed direction.

### CITATION LIST

### Patent Document

Patent Document 1: Japanese Unexamined Patent Application, Publication No. 2018-58175
Patent Document 2: Japanese Unexamined Patent Application, Publication No. 2019-922

### DISCLOSURE OF THE INVENTION

### Problems to be Solved by the Invention

In a case where a robot hand conveys an object such as a package to a prescribed position to thereby load the object, there is the possibility of causing a load collapse when attempting to load the object in a situation where there is a bad loaded state before loading, such as where there is loading deviation for objects that are already loaded or objects having various shapes have been loaded. In addition, in a case where it is difficult to load an object, the robot may perform an idle operation in a state where suction cannot be performed. Accordingly, in a case of loading an object having a different shape in at least one of width, depth, or height onto objects that are already loaded, a robot control apparatus and robot system that can place the object to be loaded at an optimal position is desirable.

### Means for Solving the Problems

A representative first aspect of the present disclosure is a robot control apparatus for controlling operation of a robot that has a robot hand provided with at least two sensors, each measuring a holding force, and that uses the robot hand to hold an object placed at a first location, lift the object, and place the object at a second location, the robot control apparatus provided with: at least one processor; and at least one storage apparatus that can store a program to be executed by the at least one processor, wherein based on the program, the at least one processor using at least two holding force values measured by the at least two sensors to determine at least one of a width, depth, or height of the object.

A representative second aspect of the present disclosure is a robot system that is provided with the robot control apparatus according to the above-described first aspect, and a robot that is controlled by the robot control apparatus.

### BRIEF DESCRIPTION OF THE DRAWINGS

FIG. 1 is a block diagram that illustrates an example of a configuration of a robot system according to one embodiment of the present invention.

FIG. 2 is a bottom view in which a suction hand is seen from a side where a plurality of suction pads are arranged.

FIG. 3 is a view for describing conveyance between pallets of packages, using the suction hand.

FIG. 4 is a view that illustrates a path for conveying a package using the suction hand.

FIG. 5 is a view that illustrates a situation in which the suction hand has become oblique with respect to a package, at the time of a suction operation.

FIG. 6 is a view that illustrates a situation in which the suction hand is suctioning in a manner that is deviated with respect to a package, at the time of a suction operation.

FIG. 7 is a view for describing a method for suppressing a package moving away from suction pads.

FIG. 8 is a view for describing a method for suppressing a package moving away from suction pads.

FIG. 9 is a bottom view in which the suction hand, when a package is suctioned, is seen from a side where the plurality of suction pads are arranged.

FIGS. 10A through 10C are partial enlarged views of a region centered on a negative pressure sensor 1022A in a state where packages having respectively different sizes are suctioned.

FIG. 11 is a bottom view in which the suction hand, when a package is suctioned, is seen from a side where the plurality of suction pads are arranged, in a state where the center of the suction hand does not match the center of the package.

FIG. 12 is a view for describing an operation for loading a package to an optimal position on a pallet using the suction hand.

FIG. 13 is a flow chart that illustrates a control operation of the robot control apparatus.

FIG. 14 is a block view that illustrates an example of a configuration in a case where the robot control apparatus is configured by a computer.

### PREFERRED MODE FOR CARRYING OUT THE INVENTION

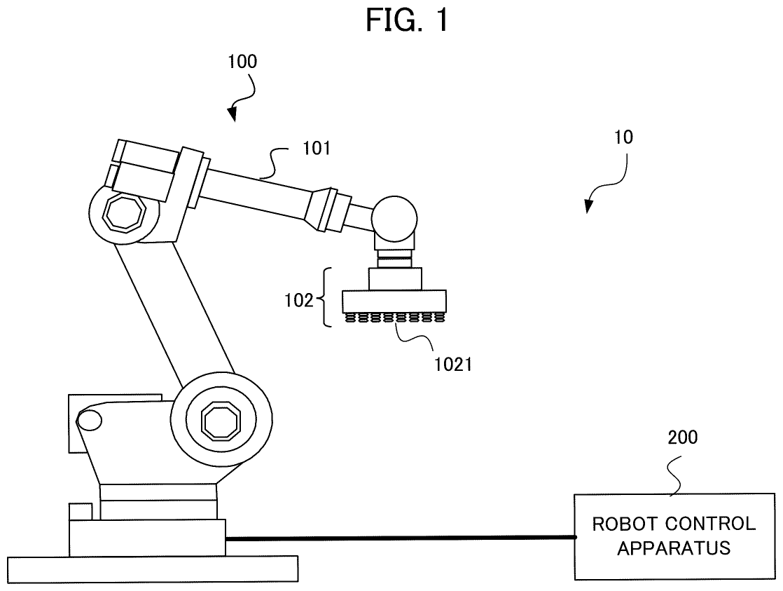

With reference to the drawings, description is given below regarding details of embodiments of the present invention. FIG. 1 is a block diagram that illustrates an example of a configuration of a robot system according to one embodiment of the present invention.

As illustrated in FIG. 1, a robot system 10 is provided with a robot 100 for conveying an object, and a robot control apparatus 200 that controls operation of the robot 100. The robot 100 and the robot control apparatus 200 are connected via a cable.

The robot 100 is provided with a robot mechanism 101, and a suction hand 102 that is attached to the tip of the robot mechanism 101. The suction hand 102 will serve as a robot hand.

The robot mechanism 101 has a plurality of joint shafts, and a motor is provided for each of the plurality of joint shafts. Each motor is controlled using an operation command from the robot control apparatus 200. By controlling each motor, the robot mechanism 101 can move the suction hand 102 vertically and horizontally.

The suction hand 102 is provided with a vacuum generator, a regulator for generating negative pressure (which is a pressure difference in the negative direction with respect to atmospheric pressure), and a plurality of negative pressure sensors for measuring the negative pressure. The negative pressure sensors will serve as sensors for measuring holding force. The suction hand 102 is provided with a plurality of suction pads (may also be referred to as vacuum pads) 1021, the inside of the plurality of suction pads being set to the negative pressure using the vacuum generator and the regulator, and the suction hand 102 becomes capable of conveying a package by the plurality of suction pads 1021 suctioning a surface of the package while the inside of the plurality of suction pads 1021 is set to the negative pressure. The suction hand 102 is provided with the regulator that controls the value of the negative pressure, but there are cases in which the negative pressure fluctuates due to the shape of the package that will be an object to convey, the state of holding by the suction hand 102, and the state of the vicinity thereof. In the case where the negative pressure has fluctuated, the force by which the suction hand 102 grabs the package 300 by suction (referred to as suction force below) fluctuates. The value of the negative pressure becomes a value that indicates the suction force, which will serve as the holding force.

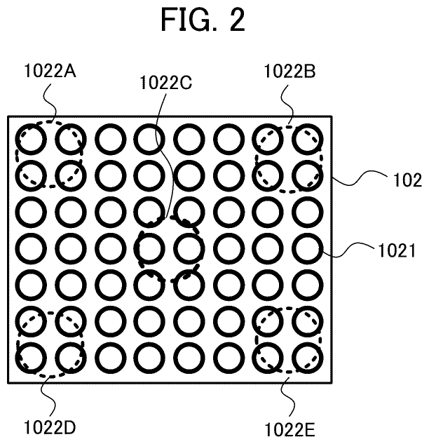

FIG. 2 is a bottom view in which the suction hand is seen from a side where the plurality of suction pads are arranged. The suction hand 102 illustrated in FIG. 2 is provided with 56 suction pads 1021 arrayed in eight columns by seven rows, and five negative pressure sensors 1022A to 1022E for measuring negative pressure. The negative pressure sensors 1022A, 1022B, 1022D, and 1022E each measure the negative pressure of four suction pads. The negative pressure sensor 1022C also measures the negative pressure of approximately four suction pads. An example in which the number of negative pressure sensors is five is described here, but the number of negative pressure sensors may be two or more, or a negative pressure sensor may be provided for each of the plurality of suction pads 1021.

An adjustment valve is provided inside each of the plurality of suction pads 1021. The adjustment valve is closed when the pressure becomes high to thereby suppress a leak between the suction pad and a package and prevent a decrease in the negative pressure even in a case where the suction pad does not face the package, enabling the package to be conveyed.

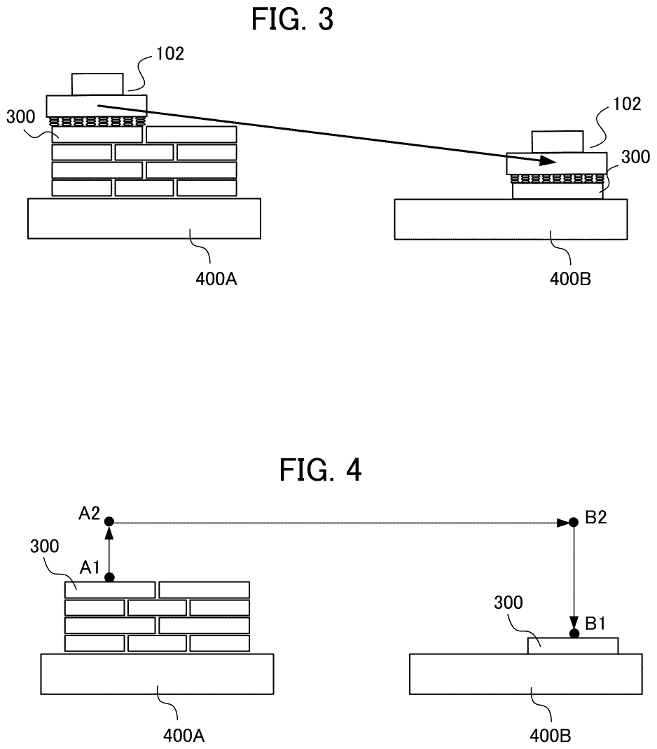

Using FIG. 3 and FIG. 4, description is given below regarding a package conveyance operation using a suction hand. FIG. 3 is a view for describing conveyance between pallets of packages, using the suction hand. FIG. 4 is a view that illustrates a path for conveying a package using the suction hand. In FIG. 3, positions A1, A2, B2, and B1 indicate positions at which the package 300 is in contact with a suction pad 1021 positioned at the center of the suction hand 102. The positions A1, A2, B2, and B1 are changed when the package to be conveyed changes, and the path for conveying the package also changes.

The robot control apparatus 200 controls suction and detachment operations by the suction hand 102 as well as conveyance operations by the suction hand 102 using the robot mechanism 101. As illustrated in FIG. 4, the suction hand 102 conveys the package 300, which has been placed on a pallet 400A, to a pallet 400B by a conveyance path that is for the package 300 and is in the order of the positions A1, A2, B2, and B1.

The robot control apparatus 200 performs an operation in which the suction hand 102 suctions the package 300 at position A1, and an operation in which the suction hand 102 conveys (raises) the package 300 vertically between the positions A1 and A2. Subsequently, the robot control apparatus 200 performs an operation in which the suction hand 102 horizontally conveys the package 300 between the positions A2 and B2, and performs an operation in which the suction hand 102 vertically conveys (lowers) the package 300 between the positions B2 and B1. The robot control apparatus 200 performs an operation in which the suction hand 102 places and detaches from the package 300 at the position B1 to thereby load the package 300. In the present embodiment, a first location refers to the position A1 on the pallet 400A, for example. In the present embodiment, a second location refers to the position B1 on the pallet 400B, for example.

FIG. 3 and FIG. 4 illustrates an initial operation in which the suction hand 102 places the package 300 in a state where a package has not been placed on the pallet 400B, but second and subsequent operations in which the suction hand 102 places the package 300 are in a state where a package has been placed on the pallet 400B.

The robot control apparatus 200 performs the following operations along the conveyance path for the package 300 in the order of the positions A1, A2, B2, and B1.
(1) At the position A1 for performing a suction operation, the robot control apparatus 200 measures the value of negative pressure at the negative pressure sensors 1022A to 1022E in the suction hand 102. The robot control apparatus 200 performs an operation for determining that a portion where the value of negative pressure is small is where the distance between the suction hand 102 and the package 300 has increased, changing the orientation of the suction hand 102, and pressing the suction hand 102 toward a portion where the negative pressure is weak. Subsequently, between the positions A1 and A2 that are for performing an operation for conveying the package vertically, the robot control apparatus 200 causes the suction hand 102 that has suctioned the package 300 to rise.
(2) In a case where there is a small negative pressure value from among five negative pressure values measured by the negative pressure sensors 1022A to 1022E between the positions A2 and B2 that are for performing an operation for conveying a package horizontally, the robot control apparatus 200 operates the robot 100 such that the small negative pressure value increases.
(3) Between the positions B2 and B1 that are for performing an operation for conveying (lower) vertically or at the position B1 for placing the package 300, the robot control apparatus 200 measures the negative pressure values from the negative pressure sensors 1022A to 1022E to thereby ascertain the width and depth of the package 300. The “width” and the “depth” may be respectively referred to as the “length” and “width”. The width and depth of the package 300 may be ascertained at the position A1 or between the positions A2 and B2. Because the negative pressure value for each negative pressure sensor increases when placing at the position B1, the robot control apparatus 200 ascertains the height of the package 300.
(4) After having ascertained the width, depth, and height of the package 300, as described below, the robot control apparatus 200 ascertains the weight of the package 300 based on the torque of the joint shaft motors. The robot control apparatus 200 performs placement after calculating an optimal placement position that considers four parameters: the width, depth, height, and weight of the package 300.

Further description is given below regarding details of the suction operation at the position A1, the conveyance operation in the horizontal direction between the positions A2 and B2, and the conveyance operation in the vertical direction between the positions B2 and B1 or a loading (placing) operation at the position B2.

### Suction Operation

At the position A1, the robot control apparatus 200 measures the negative pressure values from the negative pressure sensors 1022A to 1022E in the suction hand 102 that has suctioned the package 300, and obtains a difference between the negative pressure values measured by the negative pressure sensors 1022A to 1022E. The robot control apparatus 200 adjusts the orientation or arrangement of the suction hand 102 with respect to the package 300 such that the difference between negative pressure values ceases, and then causes the suction hand 102 to suction the package 300.

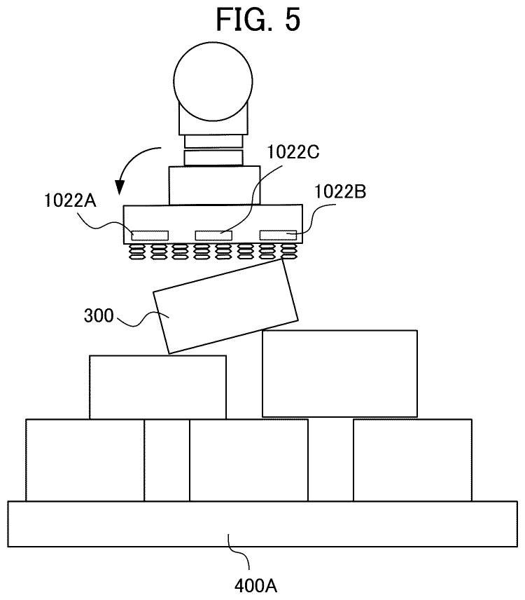

For example, in a situation where the suction hand 102 is oblique with respect to the package 300 as illustrated in FIG. 5, a difference in negative pressure values arises between the negative pressure sensor 1022A and the negative pressure sensor 1022B, as well as between the negative pressure sensor 1022C and the negative pressure sensor 1022D. In this case, the robot control apparatus 200 determines that the package 300 has been loaded obliquely, and controls the robot mechanism 101 such that there ceases to be the difference in negative pressure values between the negative pressure sensor 1022A and the negative pressure sensor 1022B, as well as between the negative pressure sensor 1022C and the negative pressure sensor 1022D. As a result, the orientation is changed such that the suction hand 102 becomes parallel to the package 300.

In a case where the suction hand 102 suctions the package 300, even if the negative pressure values (which serve as holding force values) from the negative pressure sensors 1022A to 1022E are each equal to or greater than a prescribed value (which is a holding force prescribed value), in a case where a suction surface (which is a holding surface) of the package 300 is smaller than a prescribed value (which is a holding surface prescribed value), it is desirable to execute placing by the suction hand 102 again, set each negative pressure value from the negative pressure sensors 1022A to 1022E to the prescribed value (holding force prescribed value) or more, and set the suction surface of the package to a prescribed value (suction surface prescribed value) or more.

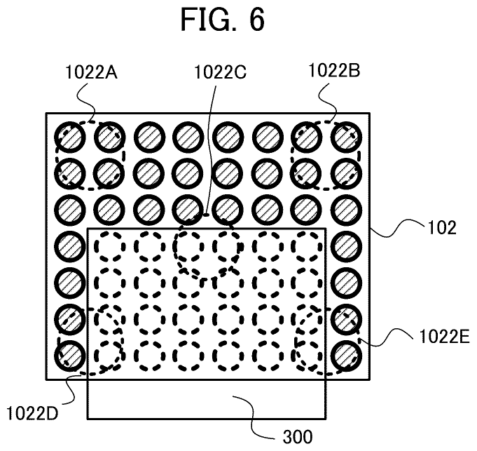

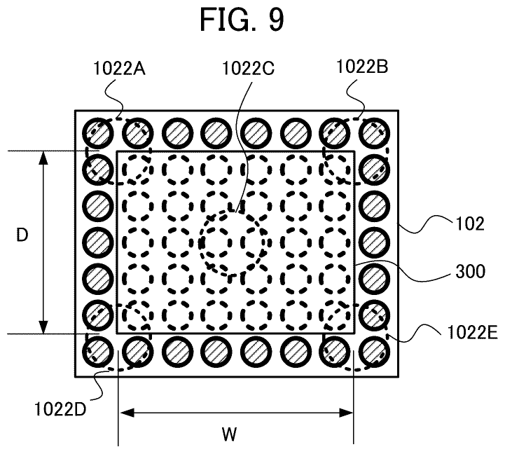

For example, in a case where the surface (suction surface) of the package 300 that has been suctioned is small due to the package 300 having deviated with respect to the area of the bottom surface of the suction hand 102 on which 56 suction pads are arranged as illustrated in FIG. 6, the adjustment valves are closed for the suction pads that have deviated from the suction surface, whereby a leak from the suction pads is suppressed. Accordingly, even if the suction surface of the package 300 is small, all negative pressure values (holding force values) from the negative pressure sensors 1022A to 1022E each becomes equal to or greater than the prescribed value (which serves as the holding force prescribed value). In FIG. 6, suction pads for which the adjustment valve is closed are illustrated by circles having diagonal lines inside. However, in a case where the suction surface of the package 300 is smaller than a prescribed value (which is a holding surface prescribed value), only 24 suction pads from among the 56 suction pads contribute to suction in the case illustrated in FIG. 6. Therefore, for example, placing the suction hand 102 again to an arrangement as illustrated in later-described FIG. 9 is executed such that the negative pressure values from the negative pressure sensors 1022A to 1022E each becomes equal to or greater than a prescribed value (the holding force prescribed value), and the suction surface of the package becomes equal to or greater than a prescribed value (the suction surface prescribed value). Whether the suction surface of the package 300 becomes smaller than the holding surface prescribed value can be determined based on the negative pressure values from the negative pressure sensors 1022A to 1022E. Assuming that there is, for the most part, no leak from suction pads for which the adjustment valves have been closed, the negative pressure increases when the number of suction pads for which the adjustment valves have been closed increases. Accordingly, by measuring negative pressure values, it is possible to know the number of suction pads for which the adjustment valves have been closed, and it is possible to evaluate the size of the surface that is not being suctioned to thereby determine the size of the suction surface of the package 300.

Upon comparing the suction state in FIG. 6 with the suction state in later-described FIG. 9, for example, the adjustment valves in the four suction pads corresponding to each of the negative pressure sensors 1022A and 1022B are all closed in the suction state in FIG. 6. Therefore, the negative pressure according to the negative pressure sensors 1022A and 1022B is higher in the suction state in FIG. 6 that in the suction state in FIG. 9. In addition, in the suction state in FIG. 6, the number of closed adjustment valves from among the adjustment valves in the four suction pads corresponding to each of the negative pressure sensors 1022D and 1022E is fewer by one in the suction state in FIG. 6 than the suction state in FIG. 9. Therefore, the negative pressure according to the negative pressure sensors 1022D and 1022E is smaller in the suction state in FIG. 6 than in the suction state in FIG. 9. In addition, in the suction state in FIG. 6, closed adjustment valves are included in the adjustment valves in the four suction pads corresponding to the negative pressure sensor 1022C. Therefore, the negative pressure according to the negative pressure sensors 1022D and 1022E is higher in the suction state in FIG. 6 than in the suction state in FIG. 9.

Accordingly, by measuring the negative pressure values from the negative pressure sensors 1022A, 1022B, 1022B, 1022D, and 1022E, it is possible to more or less know the number of suction pads for which the adjustment valve is closed, and it is possible to determine the number of remaining suction pads to thereby evaluate the size of the suction surface of the package 300.

### Conveyance Operation in Horizontal Direction

In the horizontal conveyance (movement) section between the positions A2 and B2 after the robot control apparatus 200 has caused the suction hand 102 to rise from the position A1 to the position A2, the robot control apparatus 200 measures the negative pressure values from the negative pressure sensors 1022A to 1022E in the suction hand 102, and determines a difference in the negative pressure values measured by the negative pressure sensors 1022A to 1022E. In a case where the difference in negative pressure values is equal to or greater than a certain value or in a case where the difference in negative pressure values has become large, the robot control apparatus 200 determines that the package 300 has started moving away from the suction pads 1021, and controls the robot mechanism 101 such that the package 300 does not move away from the suction pads 1021.

For example, similarly to a time of the suction operation at the position A1, in the horizontal conveyance (movement) section between the positions A2 and B2, it is assumed that a difference in negative pressure values has arisen between the negative pressure sensor 1022A and the negative pressure sensor 1022B as well as between the negative pressure sensor 1022C and the negative pressure sensor 1022D. In this case, the robot control apparatus 200 determines that the package 300 has started moving away from the suction pads 1021, and controls the robot mechanism 101 such that the difference in negative pressure values between the negative pressure sensor 1022A and the negative pressure sensor 1022B as well as between the negative pressure sensor 1022C and the negative pressure sensor 1022D cease to be or decrease.

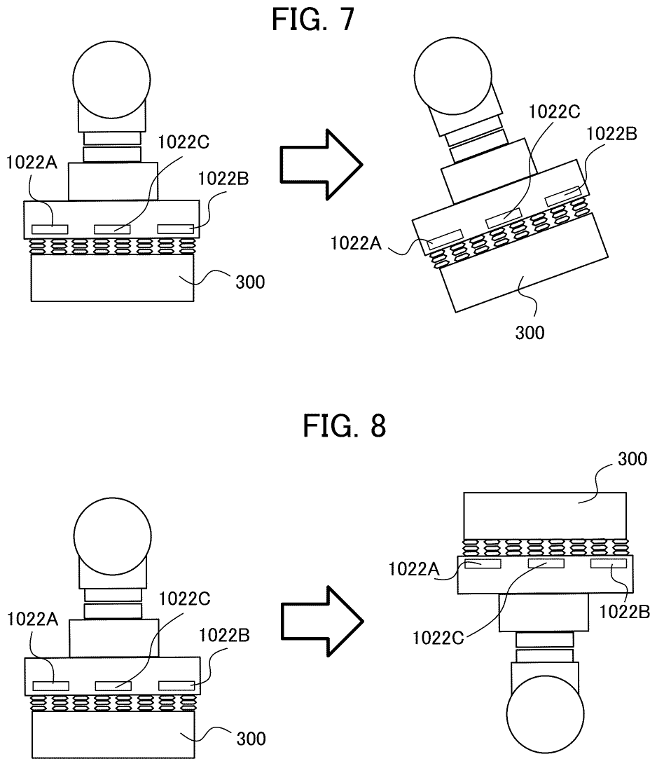

A method by which the robot control apparatus 200 controls the robot mechanism 101 such that the package 300 does not move away from the suction pads 1021 is not particularly limited, but there are the following two methods, for example.
(1) As illustrated in FIG. 7, the robot mechanism 101 rotates counterclockwise to tilt the suction hand 102 that is suctioning the package 300, and accelerates in the conveyance direction. Upon doing so, a force pressing the package 300 onto the suction hand 102 works, and it is possible suppress the package 300 from moving away from the suction pads 1021.
(2) As illustrated in FIG. 8, the robot mechanism 101 rotates, by 180 degrees, the suction hand 102 that is suctioning the package 300. Upon doing so, the package 300 is pressed onto the suction hand 102 by gravity, and it is possible suppress the package 300 from moving away from the suction pads 1021. When the suction hand 102 reaches the position B2, the robot mechanism 101 performs an operation for vertically moving (lowering) the suction hand 102 that is suctioning the package 300 after rotating the suction hand 102 by 180 degrees to return to the original orientation.

### Conveyance Operation in Vertical Direction or Loading Operation

Between the positions B2 and B1 for performing a conveyance operation in the vertical direction or at the position B1 for performing a loading (placing) operation, the robot control apparatus 200 performs an operation for ascertaining the width, depth, and height of the package 300 in accordance with measurement values from the negative pressure sensors 1022A to 1022E. In addition, the robot control apparatus 200 performs an operation for ascertaining the weight of the package 300 at the position B1.

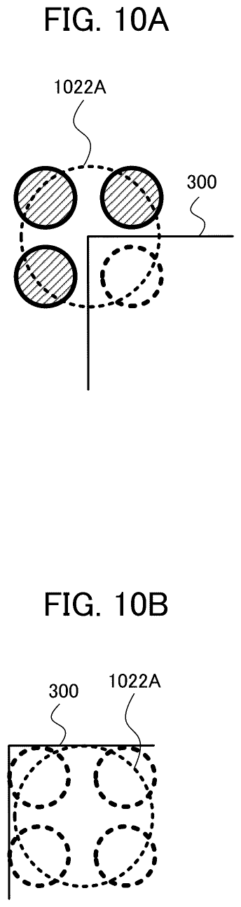

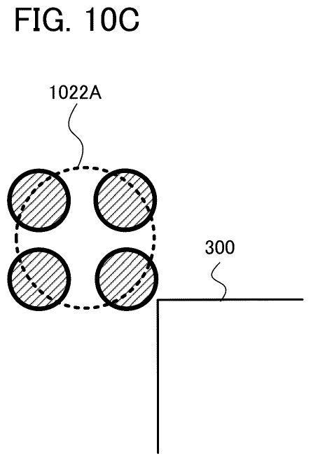

Firstly, description is given regarding an operation for ascertaining the width and depth of the package 300. FIG. 9 is a bottom view in which the suction hand, when a package is suctioned, is seen from a side where the plurality of suction pads are arranged. FIGS. 10A through 10C are partial enlarged views of a region centered on the negative pressure sensor 1022A in a state where packages having respectively different sizes are suctioned.

As illustrated in FIG. 9, in a case where the area of the package 300 is small with respect to the area of the bottom surface of the suction hand 102 where the 56 suction pads 1021 are arranged, 26 suction pads arranged closest to the four sides of the bottom surface of the suction hand 102 will not be able to suction the package 300, the adjustment valves provided corresponding to the suction pads 1021 are closed, whereby a leak from the suction pads 1021 is suppressed. In FIG. 9, suction pads 1021 for which the adjustment valve is closed are illustrated by circles having diagonal lines inside.

In a case where the package 300 is suctioned by the suction hand 102 as illustrated in FIG. 9, for example, when attention is given to the negative pressure sensor 1022A, the adjustment valve is closed for three of the four suction pads 1021 as illustrated in FIG. 10A, and a leak occurs between one suction pad 1021 and the package 300. Assume that the negative pressure measured by the negative pressure sensor 1022A at this point is P1. In contrast, in a case where the area of the bottom surface of the suction hand 102 is substantially equal to the area of the package 300 that is suctioned and the bottom surface of the suction hand 102 overlaps with the surface of the package 300, for example, when attention is paid to the negative pressure sensor 1022A, a leak occurs between the four suction pads and the package as illustrated in FIG. 10B. Assume that the negative pressure measured by the negative pressure sensor 1022A at this point is P2. With respect to the area of the bottom surface of the suction hand 102, in a case where the area of the suctioned package 300 is even smaller than the area illustrated in FIG. 9, for example, when attention is paid to the negative pressure sensor 1022A, the adjustment valves are closed for the four suction pads as illustrated in FIG. 10C, and a leak does not occur between the suction pads and the package. Assume that the negative pressure measured by the negative pressure sensor 1022A at this point is P3.

When there is more or less no leak from the suction pads 1021 for which the adjustment valves are closed, the value P1 of the negative pressure measured in the state in FIG. 10A, the value P2 of the negative pressure measured in the state in FIG. 10B, and the value P3 of the negative pressure measured in the state in FIG. 10C have the relationship P3>P1>P2.

If the negative pressures measured by the negative pressure sensors 1022A, 1022B, 1022D, and 1022E are all P1, it is possible to infer that a depth D of the package is the array length of five suction pads 1021 and infer that a width W of the package is the array length of six suction pads 1021, as illustrated in FIG. 9.

If the negative pressures measured by the negative pressure sensors 1022A, 1022B, 1022D, and 1022E are all P2, it is possible to infer that the depth D of the package is the array length of seven suction pads 1021 and infer that the width W of the package is the array length of eight suction pads 1021.

If the negative pressures measured by the negative pressure sensors 1022A, 1022B, 1022D, and 1022E are all P3 and the negative pressure measured by the negative pressure sensor 1022A is P3, it is possible to infer that the depth D of the package is the array length of three suction pads 1021 and infer that the width W of the package is the array length of four suction pads 1021.

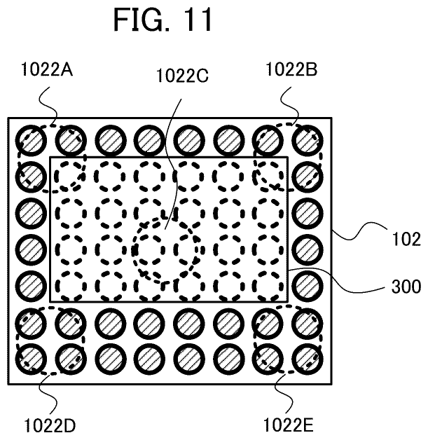

The example illustrated in FIG. 9 is for a case where the center of the suction hand matches the center of the package, but it is possible to estimate the depth D and width W of the package even in a case where the center of the suction hand 102 does not match the center of the package 300, as illustrated in FIG. 11. The package 300 illustrated in FIG. 11 is smaller than the package 300 illustrated in FIG. 9.

With the arrangement between the suction hand 102 and the package 300 illustrated in FIG. 11, if the negative pressures measured by the negative pressure sensors 1022A and 1022B are P1, the negative pressures measured by the negative pressure sensors 1022D and 1022E are P3, and the negative pressure measured by the negative pressure sensor 1022A is P2, it is possible to infer that the depth D of the package is the array length of four suction pads 1021 and infer that the width W of the package is the array length of six suction pads 1021.

The example described above is for a case where the number of negative pressure sensors is five, but it is possible to estimate the depth and width of a package if the number of negative pressure sensors is two or more. For example, in a case where two-the negative pressure sensor 1022A and the negative pressure sensor 1022D-are provided, it is possible to estimate the depth and width of a package if the suction hand 102 is caused to rotate by 90 degrees.

In a case of desiring to more accurately determine the depth D and width W of the package, a negative pressure sensor may be provided for each suction pad. In this case, it may be that negative pressure sensors do not need to be respectively provided for all suction pads, or it may be that a negative pressure sensor is provided for a plurality of suction pads that are a portion from among all the suction pads. In addition, in a case of desiring to ascertain the depth D and the width W of the package 300, it may be that ascertaining is performed during the conveyance operation in the vertical direction between the positions B2 and B1, or the depth D and the width W of the package 300 may be ascertained after the package is placed at a placement location in one instance. In the above description, both of the depth D and the width W of a package are ascertained, but it may be that only one is ascertained. In addition, it may be that only the height of a package as described below is ascertained, without ascertaining either the depth D or the width W of the package.

Next, description is given regarding an operation for ascertaining the height of a package. When the package 300 is placed on the pallet at the position B1, a gravitational force from the package 300 ceases to be applied to the suction hand 102. Therefore, the suction hand 102 and the package 300 are in close contact, and measured negative pressure pressures become large. The height h of the tip of the suction pads of the suction hand 102 at this time becomes a value resulting from adding the height h2 of the package to the height h1 of the pallet (or the height resulting from adding the loaded object to the pallet). Accordingly, the height h2 of the package can be determined by h−h1.

Next, description is given regarding an operation for ascertaining the weight of a package. Between the positions B2 and B1, the robot control apparatus 200 moves (lowers) the package 300 by controlling the motors for the joint shafts. When the package 300 is stopped and placed on the pallet, a force due to acceleration/deceleration ceases to be applied, and the motor torque depends on the weight of the package 300. The motor torque is obtained by multiplying a torque constant by a current value. Therefore, the robot control apparatus 200 can detect the current flowing through a motor to thereby determine the motor torque and ascertain the weight of the package. An apparatus for determining the motor torque and ascertaining the weight of a package is described in Japanese Unexamined Patent Application, Publication No. 2020-151812, for example.

Description was given above regarding an operation in which the robot control apparatus 200 ascertains the width, depth, height, and weight of a package in accordance with measurement values from negative pressure sensors between the positions B2 and B1 or at the position B1. Next, description is given regarding a method for, based on the width, depth, height, and weight of a package, calculating an optimal placement position, and loading the package that is conveyed to the calculated position.

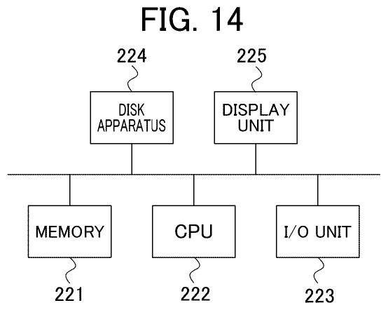

In a storage unit, the robot control apparatus 200 stores, as a load status, the package width and depth of the top package from among packages 300 that have been stacked on the pallet 400B, the height and weight of loaded objects, and the position (arrangement) at which the package 300 was loaded onto the loaded objects. For example, the storage unit is a memory 221 that is illustrated in FIG. 14. Each time a package 300 is sequentially loaded onto the pallet 400B as illustrated in FIG. 2 and FIG. 3, the robot control apparatus 200, based on the width, depth, height, and weight of the conveyed package 300, determines the width and height of the top package 300 from among the loaded objects on the pallet 400B, determines the height and the weight of the loaded objects, and updates the position (arrangement) at which the package 300 was loaded onto the loaded objects as well as the load status. The width and depth of the top package 300 from among the loaded objects on the pallet 400 as well as the position (arrangement) at which the package 300 was loaded onto the loaded objects become information that indicates the shape of the loaded objects. The height of the loaded objects is the height of the top package 300 from among the loaded objects, from the surface of the pallet 400B or the surface (ground, floor, or the like) on which the pallet 400B is placed. The weight of the loaded objects is the weight from the surface of the pallet 400B to the top package 300 from among the loaded objects, and a weight distribution for the loaded objects seen from above is stored.

The robot control apparatus 200 ascertains, between the positions B2 and B1 or at the position B1, the width, depth, height, and weight of a package that is conveyed from a position P1. From the storage unit, the robot control apparatus 200 reads out the load status for packages that have been loaded on the pallet, calculates an optimal placement position (placement location) based on the load status for the packages as well as the width, depth, height, and weight of the conveyed package, and loads the conveyed package at the calculated placement position.

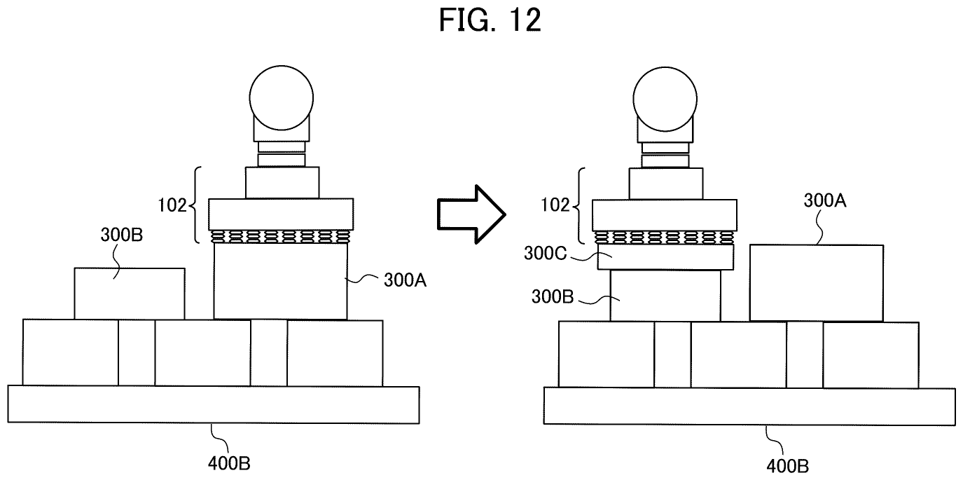

As illustrated on the left side of FIG. 12, for example, between the positions B2 and B1 or at the position B1, the robot control apparatus 200 ascertains the width, depth, height, and weight of a package 300A that is conveyed from a position P1. The robot control apparatus 200 reads out the load status for the package that was loaded on the pallet 400B from the storage unit, ascertains that there is a space adjacent to a package 300B on the pallet 400B, and determines whether a package 300A can be arranged adjacent to the package 300B from the width, depth, and height of the package 300A. In addition, the robot control apparatus 200 determines whether the package 300A can be arranged adjacent to the package 300B from the weight of the package 300A. Upon determining that arranging is possible, the robot control apparatus 200 loads the package 300A to be adjacent to the package 300B on the pallet 400B, and updates the load status stored in the storage unit to be a load status resulting from adding the loaded package 300A.

Next, the robot control apparatus 200 ascertains, between the positions B2 and B1 or at the position B1 (the surface of the package 300A), the width, depth, height, and weight of a package 300C that is conveyed from a position P1. From the storage unit, the robot control apparatus 200 reads out the load status for the package 300A and the package 300B that have been loaded onto the pallet 400B.

The robot control apparatus 200 determines on which of the package 300A and the package 300B to perform placement, from the width, depth, height, and weight of the package 300C. The arrangement is determined in consideration of the width and depth of the package 300C because it is desirable to load the package while reducing gaps on the pallet 400B. In addition, the robot control apparatus 200 determines the arrangement in consideration of the height of the package 300C such that variation in the height of loaded packages from the pallet 400B decreases. The robot control apparatus 200 also determines the arrangement in consideration of the weight of the package 300C such that the weight of loaded packages is not unevenly distributed on the pallet 400B. The view on the right side of FIG. 12 illustrates an example in which the robot control apparatus 200 loads the package 300C on the package 300B from the width, depth, height, and weight of the package 300C.

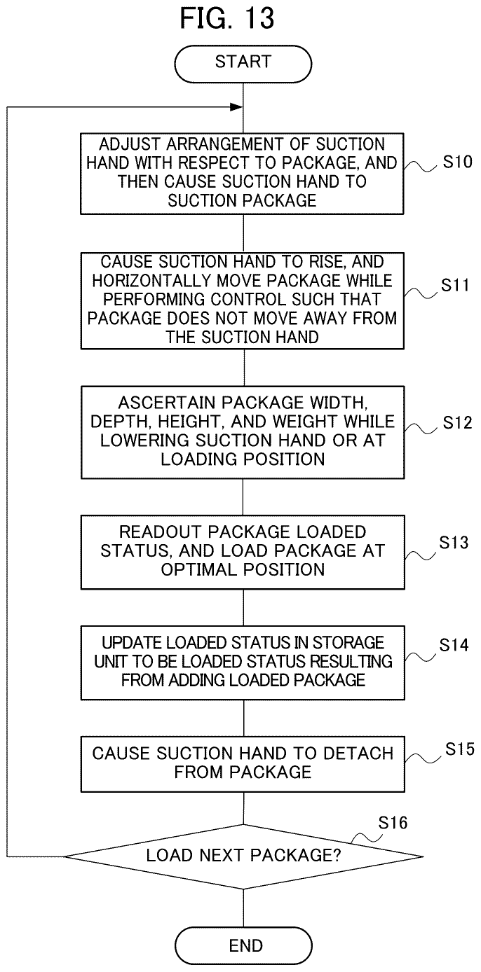

Description is given below regarding a control operation by a robot control apparatus. FIG. 13 is a flow chart that illustrates a control operation by a robot control apparatus. As illustrated in FIG. 4, the robot control apparatus 200 performs control such that the suction hand 102 conveys the package 300 on a conveyance path that is in the order of the positions A1, A2, B2, and B1.

In Step S10, the robot control apparatus 200 measures negative pressure values from the negative pressure sensors 1022A to 1022E in the suction hand 102, adjusts the arrangement (orientation) of the suction hand 102 with respect to the package 300 such that there ceases to be a difference in negative pressure values, and then causes the suction hand 102 to suction the package 300.

In Step S11, the robot control apparatus 200 causes the suction hand 102 to rise from the position A1 to the position A2 and, in a conveyance section in the horizontal direction between the positions A2 and B2, horizontally moves (horizontally conveys) the suction hand 102 while performing control such that the package does not move away from the suction hand 102. An operation by which the robot control apparatus 200 performs control such that the package 300 does not move away from the suction hand 102 is, for example, performed as follows. The robot control apparatus 200 measures negative pressure values from the negative pressure sensors 1022A to 1022E in the suction hand 102, and determines a difference in measured negative pressure values. In a case where the difference in negative pressure values is equal to or greater than a certain value or in a case where the difference in negative pressure values has fluctuated, the robot control apparatus 200 determines that the package 300 has started moving away from the suction pads 1021, and controls the robot mechanism 101 such that the package 300 does not move away from the suction pads 1021.

In Step S12, the robot control apparatus 200 ascertains the width, depth, height, and weight of the package during conveyance (lowering) in the vertical direction by the suction hand 102 or at a placement position. The width and depth of the package is determined based on the negative pressure values from the negative pressure sensors 1022A to 1022E in the suction hand 102, as already described. The height of the package is determined based on the height at a change in the negative pressure values from the negative pressure sensors 1022A to 1022E in the suction hand 102, as already described. The weight of the package is determined based on the motor torque for the joint shafts in the robot, as already described.

In Step S13, the robot control apparatus 200 reads out a package load status from the storage unit, calculates an optimal placement location based on the width, depth, height, and weight that are for the conveyed package and were determined in Step S12, and loads the conveyed package at the calculated position.

In Step S14, the robot control apparatus 200 updates the load status stored in the storage unit to be a load status resulting from adding the loaded package.

In Step S15, the robot control apparatus 200 causes the suction hand 102 to detach from the package 300.

In Step S16, the robot control apparatus 200 determines whether to load the next package, returns to Step S10 in a case of causing loading, and ends processing in a case of not causing loading. Step S10 through Step S16 are repeated, whereby the package load status stored in the storage unit is updated each time a package is sequentially loaded onto the pallet. By virtue of the above operations in Step S10 through Step S16, the package 300 is conveyed onto the pallet 400B from on top of the pallet 400A.

Components included in the robot control apparatus according to the embodiment described above can be realized by hardware, software, or a combination of these. Being realized by software means being realized by a computer reading and executing a program. In order to realize components included in the robot control apparatus by software or a combination of these, the robot control apparatus is provided with a processor such as a CPU (Central Processing Unit). The processor functions as an execution unit. The robot control apparatus may be provided with a plurality of processors that operate in parallel. In addition, the robot control apparatus is also provided with an auxiliary storage apparatus such as an HDD (Hard Disk Drive) that stores application software or various control programs such as an OS (Operating System), or a main storage apparatus such as a RAM (Random-Access Memory) for storing a program, which is necessary in order for the processor to execute functionality of the robot control apparatus and operations in FIG. 8 that were described using FIG. 5 through FIG. 13, and data that is temporarily necessary in the program. The robot control apparatus may be provided with a plurality of main storage apparatuses. Data that is stored is, for example, information pertaining to a conveyance path from the position A1 that will serve as a first location to the position B1, which will serve as a second location. This information includes coordinate information regarding the positions A1, A2, B2, and B1. The positions A1, A2, B2, and B1 are changed when the package to be conveyed changes, and the path for conveying the package also changes.

In the robot control apparatus, the processor, having read application software or the OS from the auxiliary storage apparatus and deployed the read application software or OS to the main storage apparatus, performs arithmetic processing based on the application software or OS. In addition, based on a corresponding arithmetic result, various types of hardware provided in the robot control apparatus are controlled. As a result, functional blocks according to the present embodiment are realized.

FIG. 14 is a block view that illustrates an example of a configuration in a case where the robot control apparatus is configured by a computer. As illustrated in FIG. 14, the computer that serves as the robot control apparatus is provided with the memory 221 that is a main storage apparatus and will serve as a storage apparatus, a CPU 222 that will serve as a processor, an I/O unit 223 for connecting with the robot 100 via a cable, a disk apparatus 224 such as an HDD that is an auxiliary storage apparatus, and a display unit 225. The display unit 225 displays, inter alia, a number of times packages are conveyed and a load status.

Components included in the robot control apparatus can be realized by hardware that includes an electronic circuit or the like. In addition, in the case of configuring the robot control apparatus by hardware, some or all of the functionality of each component included in the robot control apparatus can be configured by an integrated circuit (IC) such as an application-specific integrated circuit (ASIC), a gate array, a field-programmable gate array (FPGA), or a complex programmable logic device (CPLD), for example.

A program can be stored using various types of non-transitory computer-readable mediums and supplied to a computer. A non-transitory computer-readable medium includes various types of tangible storage mediums. An example of a non-transitory computer-readable medium includes a magnetic recording medium (for example, a floppy disk, magnetic tape, or a hard disk drive), a magneto-optical recording medium (for example, a magneto-optical disk), a CD-ROM (read-only memory), CD-R, CD-R/W, and a semiconductor memory (for example, a mask ROM, a programmable ROM (PROM), an erasable PROM (EPROM), a flash ROM, or a random access memory (RAM) ). In addition, a program may be supplied to a computer by various types of transitory computer-readable mediums.

The present embodiment described above can achieve effects such as the following.
(1) At the time of a suction operation, a package is suctioned by the suction hand after the arrangement (orientation) of the suction hand with respect to the package is adjusted. Therefore, there are fewer falls by the package 300, which is the main cause of an unstable suction state, and it is thus possible to prevent producing defective articles or defective items that are due to falls.
(2) At a time of conveyance in the horizontal direction, the robot mechanism is controlled such that a package does not move away from the suction pads when it is determined that the package has started to move away from the suction pads. Therefore, it is possible to prevent the package from falling partway through conveyance.
(3) It is possible to ascertain the width, depth, height, and weight of a package, and it is possible to place packages having various shapes and weights at optimal positions. Even in a case where a plurality of packages and objects having respectively different weights are reloaded, it is possible to load in consideration of an arrangement balance between light items and heavy items.
(4) Because it is possible to ascertain a load status for packages, it is possible to ascertain a state such as inclination by a loading location and prevent packages in a load from collapsing, even in a situation where there is a bad loaded state, such as where there is loading deviation for packages that are already loaded or packages having various shapes have been loaded. In addition, in a case where loading a package is difficult, it is possible to eliminate an operation in which a robot performs an idle operation in a state where suction could not be performed, and it is possible to improve conveyance ability.

In the embodiment described above, not all of the width, depth, and height of a package need to be ascertained, and it may be that one or more of the width, depth, or height of a package are ascertained, if necessary. In addition, the weight of a package does not need to be ascertained.

### Variation

The embodiment described above covered an example of conveying a package using a suction hand as a robot hand. However, a robot hand is not limited to a suction hand and, inter alia, a gripping hand used in a prize obtainment game device that acquires a prize by grasping the prize or a gripping hand that uses negative pressure, a vacuum, or pressurization to, inter alia, grasp an object may be used as a robot hand. In addition, a magnetic hand that attaches using a magnetic force may be used as a robot hand.

A gripping hand used in a prize obtainment game device that acquires a prize by grasping the prize or a gripping hand that uses negative pressure, a vacuum, or pressurization to, inter alia, grasp an object can use a pressure sensor to measure to what degree a gripper is open when an object is being grasped, and thus can measure the width and depth of an object. A method of measuring the width and depth of an object by a gripping hand is described below based on a concrete example. In addition, the weight of the object is calculated from a control apparatus, and thus can be ascertained regardless of the shape of the hand. Regarding ascertaining the height of an object at a placement location, ascertaining is possible by pressing the tip of the gripping hand in a state where the hand is closed, and referring to the location where the reaction force when doing so has increased as the height of the object.

Even with a magnetic hand, a surface adhered to using magnetism can be ascertained using a magnetic sensor or the like. Therefore, for an object smaller in size than the magnetic hand, it is possible to ascertain the width and depth while the object is being attached to and conveyed. In addition, the height of the object can similarly be ascertained by performing the pressing of the loading operation.

A concrete example of a gripping hand is described in Japanese Unexamined Patent Application, Publication No. 2021-16925, for example. Japanese Unexamined Patent Application, Publication No. 2021-16925 describes a robot hand in which a pair of fingers that can open and close correspondingly with respect to a first direction and another pair of fingers that can open and close while facing a second direction at right angles to the first direction are circumferentially arrayed around the central axis of a base. The pair of fingers and the other pair of fingers belonging to this robot hand are hollow, can open and close by deforming in response to the air pressure inside each finger, and are able to grip an object.

A method of measuring the width and depth of an object by the gripping hands described in Japanese Unexamined Patent Application, Publication No. 2021-16925 is described below. A gripping hand control unit controls the amount of air supplied to the pair of fingers that face one another, whereby the opening angle (opening amount) of the pair of fingers is set to maximum and then the opening angle is reduced. When the fingers grip an object, a gripping force (which is a holding force) is detected by pressure sensors attached to the fingers. The opening angle (opening amount) for the pair of fingers depends on the amount of air supplied. Therefore, it is possible to ascertain the width or depth of an object by determining the amount of air supplied when the gripping force is detected by the pressure sensors. By performing a similar operation regarding the other pair of fingers, it is possible to ascertain the depth or width of the object.

An effect of the robot control apparatus and robot system according to the embodiment or variation described above is, using at least two holding force values measuring by at least two sensors, to be able to ascertain at least one of the width, depth, or height of an object that is conveyed. As a result, in a case of loading an object having a different weight and shape—such as width, depth, and height—onto a loaded object, it is possible to place the object, which is to be loaded, at an optimal position.

Description was given regarding the present disclosure above, but the present disclosure is not limited to each embodiment and variation described above. The embodiment and variation can be subjected to various additions, replacements, changes, partial deletions, or the like within a scope that does not deviate from the substance of the present disclosure or within a scope that does not deviate from the substance of the present disclosure derived from the content set forth in the claims or equivalents thereto. In addition, the embodiment and variation can be worked in combination. For example, the order of operations or the order of processes in the embodiments described above is indicated as an example, and there is no limitation thereto.

The following further discloses additional remarks regarding the foregoing embodiments and variations.

### Additional Remark 1

A robot control apparatus (200) for controlling operation of a robot (100) that has a robot hand (102) provided with at least two sensors (1022A to 1022E), each measuring a holding force, and that uses the robot hand to hold an object (300) placed at a first location, lift the object, and place the object at a second location, the robot control apparatus including: at least one processor (222); and at least one storage apparatus (221) that can store a program to be executed by the at least one processor, wherein based on the program, the at least one processor uses at least two holding force values measured by the at least two sensors to determine at least one of a width, depth, or height of the object.

### Additional Remark 2

In the robot control apparatus according to Additional Remark 1, the at least one processor (222) determines the height of the object (300) when placing the object at the second location.

### Additional Remark 3

In the robot control apparatus according to Additional Remark 1, the at least one storage apparatus (221) stores a load status that includes at least one of a height or shape of a loaded object before the object (300) is loaded, and when loading the object to the second location, the at least one processor (222) determines at least one of the width, depth, or height of the object, and determines an optimal location to place the object based on the stored load status and at least one of the determined width, depth, or height of the object.

### Additional Remark 4

In the robot control apparatus according to Additional Remark 3, the at least one processor (222) determines a weight of the object (300) based on a torque of a motor that moves the robot hand (102) when the object is stopped and placed, the load status includes information pertaining to a weight of the loaded object, and the at least one processor determines the optimal location to place the object based on the determined weight of the object, the load status, and at least one of the determined width, depth, or height of the object.

### Additional Remark 5

In the robot control apparatus according to Additional Remark 3, when loading the object (300) to the second location, the at least one processor (222) determines at least one of the width, depth, or height of the object, and uses at least one of the determined width, depth, or height of the object to update the load status stored in the at least one storage apparatus (221).

### Additional Remark 6

In the robot control apparatus according to Additional Remark 1, in a case where the robot hand (102) holds the object (300) at the first location, the at least one processor (222) changes an orientation of the robot hand such that the at least two holding force values each become equal to or greater than a holding force prescribed value.

### Additional Remark 7

In the robot control apparatus according to Additional Remark 1, the at least one processor (222) executes placing by the robot hand (102) again, sets each of the at least two holding force values to be equal to or greater than a holding force prescribed value, and sets a holding surface of the object (300) to be equal to or greater than a holding surface prescribed value in a case where the holding surface of the object is less than the holding surface prescribed value, even in a case where the at least two holding force values are each equal to or greater than the holding force prescribed value in a case where the robot hand holds the object.

### Additional Remark 8

In the robot control apparatus according to claim 1, when causing the object to move horizontally, in a case where a difference between holding forces from the at least two sensors (1022A to 1022E) is equal to or greater than a certain value or in a case where a difference in negative pressure values has become large, the at least one processor (222) changes a conveyance orientation of the robot such that the difference in holding force values ceases or decreases.

### Additional Remark 9

In the robot control apparatus according to any one of Additional Remarks 1 to 8, the holding force changes over time.

### Additional Remark 10

A robot system (10), including the robot control apparatus (200) according to any one of Additional Remarks 1 to 9, and a robot (100) configured to be controlled by the robot control apparatus.

### Additional Remark 11

In the robot system according to Additional Remark 10, the robot hand is a suction hand that holds the object by suctioning the object.

### EXPLANATION OF REFERENCE NUMERALS

10 Robot system
100 Robot
101 Robot mechanism
102 Suction hand
200 Robot control apparatus
221 Memory (storage apparatus)
222 CPU (processor)
223 I/O unit
224 Disk apparatus
220 Display unit
1021 Suction pad
1022A to 1022E Negative pressure sensor
300 Package

1. A robot control apparatus for controlling operation of a robot that has a robot hand provided with at least two sensors, each measuring a holding force, and that uses the robot hand to hold an object placed at a first location, lift the object, and place the object at a second location, the robot control apparatus comprising:
at least one processor; and
at least one storage apparatus that can store a program to be executed by the at least one processor,
wherein based on the program, the at least one processor uses at least two holding force values measured by the at least two sensors to determine at least one of a width, depth, or height of the object.

2. The robot control apparatus according to claim 1, wherein the at least one processor determines the height of the object when placing the object at the second location.

3. The robot control apparatus according to claim 1, wherein
the at least one storage apparatus stores a load status that includes at least one of a height or shape of a loaded object before the object is loaded, and
when loading the object to the second location, the at least one processor determines at least one of the width, depth, or height of the object, and determines an optimal location to place the object based on the stored load status and at least one of the determined width, depth, or height of the object.

4. The robot control apparatus according to claim 3, wherein
the at least one processor determines a weight of the object based on a torque of a motor that moves the robot hand when the object is stopped and placed,
the load status includes information pertaining to a weight of the loaded object, and
the at least one processor determines the optimal location to place the object based on the determined weight of the object, the load status, and at least one of the determined width, depth, or height of the object.

5. The robot control apparatus according to claim 3, wherein when loading the object to the second location, the at least one processor determines at least one of the width, depth, or height of the object, and uses at least one of the determined width, depth, or height of the object to update the load status stored in the at least one storage apparatus.

6. The robot control apparatus according to claim 1, wherein in a case where the robot hand holds the object at the first location, the at least one processor changes an orientation of the robot hand such that the at least two holding force values each become equal to or greater than a holding force prescribed value.

7. The robot control apparatus according to claim 1, wherein the at least one processor executes placing by the robot hand again, sets each of the at least two holding force values to be equal to or greater than a holding force prescribed value, and sets a holding surface of the object to be equal to or greater than a holding surface prescribed value in a case where the holding surface of the object is less than the holding surface prescribed value, even in a case where the at least two holding force values are each equal to or greater than the holding force prescribed value in a case where the robot hand holds the object.

8. The robot control apparatus according to claim 1, wherein when causing the object to move horizontally, in a case where a difference between holding forces from the at least two sensors is equal to or greater than a certain value or in a case where a difference in negative pressure values has become large, the at least one processor changes a conveyance orientation of the robot such that the difference in holding force values ceases or decreases.

9. The robot control apparatus according to claim 1, wherein the holding force changes over time.

10. A robot system, comprising:
the robot control apparatus according to claim 1; and
a robot configured to be controlled by the robot control apparatus.

11. The robot system according to claim 10, wherein the robot hand is a suction hand that holds the object by suctioning the object.
